(19) United States
(12) Patent Application Publication
(10) Pub. No.: US 2014/0028442 A1
(43) Pub. Date: Jan. 30, 2014

(54) METHOD AND APPARATUS FOR OCCUPATION DETECTION

(71) Applicant: NEC (CHINA) CO., LTD., Beijing (CN)

(72) Inventors: Lu Yu, Beijing (CN); Lei Song, Beijing (CN); Changjian Hu, Beijing (CN); Kai Zhao, Beijing (CN)

(73) Assignee: NEC (China) Co., Ltd., Beijing (CN)

(21) Appl. No.: 13/870,582

(22) Filed: Apr. 25, 2013

(30) Foreign Application Priority Data
Jul. 30, 2012 (CN) CN201210269593.2

(51) Int. Cl. G06K 7/00

(52) U.S. Cl. CPC G06K 7/00
USPC 340/10.1

(57) ABSTRACT

A method and apparatus for occupation detection includes: estimating locations of detected objects in a segmented detection region at a current time to acquire an estimation result, and transforming each of the acquired estimation results to a corresponding binary matrix, acquiring at least one candidate matrix at the current time according to the acquired binary matrices, and performing difference estimation on each of the candidate matrices at the current time according to output probabilities at the current time of at least one binary sensor deployed in the detection region; and selecting at least one condition-compliant matrix from the candidate matrices at the current time according to the estimation results, and using the selected matrix as an occupation detection result at the current time.

### FIELD OF THE INVENTION

The present invention relates to the field of location technologies, and in particular, to a method and apparatus for occupation detection.

### BACKGROUND OF THE INVENTION

With development of sensor network technologies, sensors are more and more widely used, which enhances people's capabilities in sensing, acquiring, sampling, and real-time processing of information. In practical applications, usually a large number of sensors are randomly deployed in the working environment to implement occupation detection according to the acquired information. The occupation detection refers to detecting whether an object appears in a detection region. If an object is detected, the detection region is occupied; and the object detected in the detection region is referred to as a detected object.

A document titled “Sparse Target Counting and Localization in Sensor Networks Based on Compressive Sensing” published on the International Conference on Computer Communications (INFOCOM) of the Institute of Electrical and Electronics Engineers (IEEE) in 2011 has disclosed an occupation detection method. According to the method, by using a sensor indicating signal strength, information of one or more detected objects is acquired and the locations of the one or more detected objects in a detection region are estimated. A measurement value of the sensor is estimated according to an energy attenuation model and the estimated locations of the one or more detected objects in the detection region, and then an optimal solution is constructed in the manner of iteration by using the Greedy Matching Pursuit (GMP) algorithm based on an actual measurement value of the sensor and the estimated measurement value thereof, thereby acquiring the detection result.

During the implementation of the present invention, the inventors find that the prior art has at least the following problems:

The sensors indicative of signal strength are employed in the prior art, and signal strength inevitably suffers from various interferences. This not only increases restrictions on the environment of the occupation detection, but also affects accuracy of the detection result. In addition, when the GMP algorithm is used, the algorithm has a high dependence on the initial value. Therefore, an error in each step during iteration will cause a great impact on the subsequent derivations, and may generate a complete incorrect result, and further reduce accuracy of the detection result.

### SUMMARY OF THE INVENTION

To reduce restrictions caused by the environment to the occupation detection, and improve accuracy of the detection result, embodiments of the present invention provide a method and apparatus for occupation detection. The technical solutions are as follows:

In one aspect, a method for occupation detection is provided, where the method includes:

estimating locations of detected objects in a segmented detection region at a current time to acquire at least one estimation result, and transforming each of the acquired estimation results to a corresponding binary matrix;

acquiring at least one candidate matrix at the current time according to the acquired binary matrices, and performing difference estimation on each of the candidate matrices at the current time according to output probabilities at the current time of at least one binary sensor deployed in the detection region; and

selecting at least one condition-compliant matrix from the candidate matrices at the current time according to the estimation results, and using the selected matrix as an occupation detection result at the current time.

The acquiring at least one candidate matrix at the current time according to the acquired binary matrices specifically includes:

using the acquired binary matrices as the acquired candidate matrices at the current time; or

filtering the acquired binary matrices using the linear programming relaxation and round-up method, and using the filtered binary matrices as the acquired candidate matrices at the current time.

Alternatively, the performing difference estimation on each of the candidate matrices at the current time according to output probabilities at the current time of at least one binary sensor deployed in the detection region specifically includes:

calculating a 2-norm of an actual output probability and an estimated output probability of the binary sensor at the current time corresponding to each of the candidate matrices at the current time, and using the acquired 2-norm as the estimation result of the difference estimation on each of the candidate matrices at the current time.

The selecting at least one condition-compliant matrix from the candidate matrices at the current time according to the estimation results specifically includes:

selecting at least one 2-norm reaching a threshold from the 2-norms acquired by calculation, and using the candidate matrix corresponding to the 2-norm reaching the threshold as the selected condition-compliant matrix.

Alternatively, the performing difference estimation on each of the candidate matrices at the current time according to output probabilities at the current time of at least one binary sensor deployed in the detection region specifically includes:

calculating a Hamming distance between each of the candidate matrices at the current time and an occupation detection result at a previous time, calculating a 2-norm of an actual output probability and an estimated output probability of the binary sensor at the current time corresponding to each of the candidate matrices at the current time, and using a sum of the Hamming distance and the 2-norm as the estimation result of the difference estimation on each of the candidate matrices at the current time.

The selecting at least one condition-compliant matrix from the candidate matrices at the current time according to the estimation results specifically includes:

selecting at least one sum of the Hamming distance and the 2-norm reaching a threshold from the sums of the Hamming distances and the 2-norms, and using a candidate matrix corresponding to the sum of the Hamming distance and the 2-norm reaching the threshold as the selected condition-compliant matrix.

Alternatively, prior to the calculating a 2-norm of an actual output probability and an estimated output probability of the binary sensor at the current time corresponding to each of the candidate matrices at the current time, the method further includes:

acquiring output probabilities matrix of the binary sensor corresponding to each of the candidate matrices at the current time; and

acquiring an estimation output probability of the binary sensor at the current time corresponding to each of the candidate matrices at the current time according to each of the candidate matrices at the current time and the output probability matrix of the binary sensor corresponding thereto.

In another aspect, an apparatus for occupation detection is provided, where the apparatus includes:

an estimating module, configured to estimate locations of detected objects in a segmented detection region at a current time to acquire at least one estimation result, and transform each of the acquired estimation results to a corresponding binary matrix;

a first acquiring module, configured to acquire at least one candidate matrix at the current time according to the acquired binary matrices acquired by the estimating module;

a calculating module, configured to perform, according to output probabilities at the current time of at least one binary sensor deployed in the detection region, difference estimation on each of the candidate matrices acquired by the first acquiring module; and

a selecting module, configured to select, according to the estimation results acquired by the calculating module, at least one condition-compliant matrix from the candidate matrices at the current time acquired by the first acquiring module, and use the selected matrix as an occupation detection result at the current time.

The first acquiring module is specifically configured to use the acquired binary matrices acquired by the estimating module as the acquired candidate matrices at the current time; or filter, using the linear programming relaxation and round-up method, the acquired binary matrices acquired by the estimating module, and use the filtered binary matrices as the acquired candidate matrices at the current time.

Alternatively, the calculating module is specifically configured to calculate a 2-norm of an actual output probability and an estimated output probability of the binary sensor at the current time corresponding to each of the candidate matrices at the current time, and use the acquired 2-norm as the estimation result of the difference estimation on each of the candidate matrices at the current time. The selecting module is specifically configured to select at least one 2-norm reaching a threshold from the 2-norms acquired by calculation, and use the candidate matrix corresponding to the 2-norm reaching the threshold as the selected condition-compliant matrix.

The calculating module is specifically configured to calculate a Hamming distance between each of the candidate matrices at the current time and an occupation detection result at a previous time, calculate a 2-norm of an actual output probability and an estimated output probability of the binary sensor at the current time corresponding to each of the candidate matrices at the current time, and use a sum of the Hamming distance and the 2-norm as the estimation result of the difference estimation on each of the candidate matrices at the current time.

The selecting module is specifically configured to select at least one sum of the Hamming distance and the 2-norm reaching a threshold from the sums of the Hamming distances and the 2-norms, and use a candidate matrix corresponding to the sum of the Hamming distance and the 2-norm reaching the threshold as the selected condition-compliant matrix.

Alternatively, the apparatus further includes:

a second acquiring module, configured to acquire output probabilities matrix of the binary sensor corresponding to each of the candidate matrix at the current time; and acquire an estimation output probability of the binary sensor at the current time corresponding to each of the candidate matrix at the current time according to each of the candidate matrix at the current time and the output probability matrix of the binary sensor corresponding thereto.

The technical solutions provided in the embodiments of the present invention achieve the following beneficial effects:

Since the binary sensor has a lower dependence on the environment, the binary sensor is deployed in the detection region, difference estimation is performed on each of the candidate matrices at the current time according to output probabilities of the binary sensor at the current time, and an occupation detection result at the current time is selected according to the estimation results. This reduces restrictions caused by the environment to the occupation detection, and improves accuracy of the detection result.

### BRIEF DESCRIPTION OF THE DRAWINGS

For a better understanding of the technical solutions in the embodiments of the present invention, the accompanying drawings for illustrating the embodiments are briefly described below. Apparently, the accompanying drawings in the following description illustrate only some embodiments of the present invention, and a person skilled in the art can derive other accompanying drawings from these accompanying drawings without any creative efforts.

FIG. 1 is a flowchart of a method for occupation detection according to Embodiment 1 of the present invention;

FIG. 2 is a flowchart of a method for occupation detection according to Embodiment 2 of the present invention;

FIG. 3 is a schematic diagram of a detection region according to Embodiment 2 of the present invention;

FIG. 4 is a schematic location diagram of a detection object according to Embodiment 2 of the present invention;

FIG. 5 is a diagram of probability curve of output of a binary sensor according to Embodiment 2 of the present invention;

FIG. 6 is a schematic location diagram of the detection object corresponding to an occupation detection result according to Embodiment 2 of the present invention;

FIG. 7 is a flowchart of a method for occupation detection according to Embodiment 3 of the present invention;

FIG. 8 is a schematic structural diagram of an apparatus for occupation detection according to Embodiment 4 of the present invention; and

FIG. 9 is a schematic structural diagram of another apparatus for occupation detection according to Embodiment 4 of the present invention.

### DETAILED DESCRIPTION OF THE EMBODIMENTS

To make the objectives, technical solutions, and advantages of the present invention clearer, the following describes the embodiments of the present invention in detail below with reference to the accompanying drawings.

### Embodiment 1

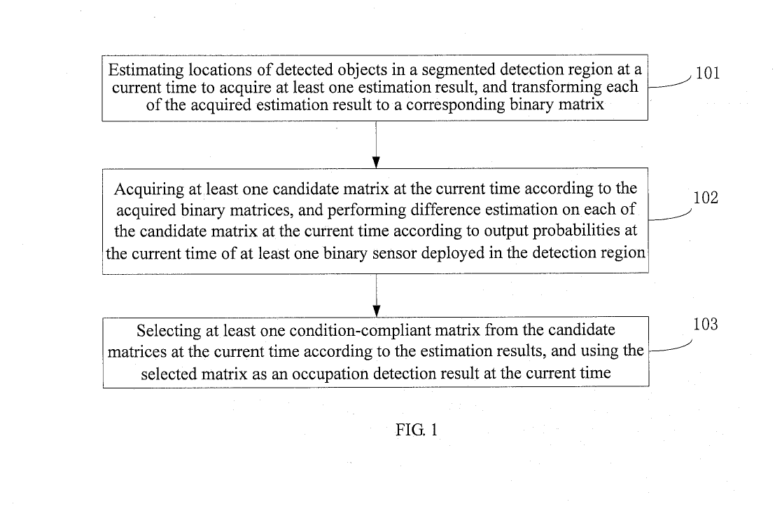

This embodiment provides a method for occupation detection. The method implements occupation detection by using a binary sensor, and further reduces restrictions caused by the environment to the occupation detection, and improves accuracy of the detection result. Referring to FIG. 1, the method provided in this embodiment includes the following steps:

101: estimating locations of detected objects in a segmented detection region at a current time to acquire at least one estimation result, and transforming each of the acquired estimation results to a corresponding binary matrix.

102: acquiring at least one candidate matrix at the current time according to the acquired binary matrices, and performing difference estimation on each of the candidate matrices at the current time according to output probabilities at the current time of at least one binary sensor deployed in the detection region.

The acquiring at least one candidate matrix at the current time according to the acquired binary matrices includes but is not limited to:

using the acquired binary matrices as the acquired candidate matrices at the current time; or

filtering the acquired binary matrices using the linear programming relaxation and round-up method, and using the filtered binary matrices as the acquired candidate matrices at the current time.

103: selecting at least one condition-compliant matrix from the candidate matrices at the current time according to the estimation results, and using the selected matrix as an occupation detection result at the current time.

The performing difference estimation on each of the candidate matrices at the current time according to output probabilities at the current time of at least one binary sensor deployed in the detection region at the current time includes but is not limited to:

calculating a 2-norm of an actual output probability and an estimated output probability of the binary sensor at the current time corresponding to each of the candidate matrices at the current time, and using the acquired 2-norm as the estimation result of the difference estimation on each of the candidate matrices at the current time.

Correspondingly, the selecting at least one condition-compliant matrix from the candidate matrices according to the estimation results includes but is not limited to:

selecting at least one 2-norm reaching a threshold from the 2-norms acquired by calculation, and using the candidate matrix corresponding to the 2-norm reaching the threshold as the selected condition-compliant matrix.

Alternatively, the performing difference estimation of each of the candidate matrices at the current time according to output probabilities at the current time of at least one binary sensor deployed in the detection region includes but is not limited to:

calculating a Hamming distance between each of the candidate matrices at the current time and an occupation detection result at a previous time, calculating a 2-norm of an actual output probability and an estimated output probability of the binary sensor at the current time corresponding to each of the candidate matrices at the current time, and using a sum of the Hamming distance and the 2-norm as the estimation result of the difference estimation on each of the candidate matrices at the current time.

Correspondingly, the selecting at least one condition-compliant matrix from the candidate matrices at the current time according to the estimation results includes but is not limited to:

selecting at least one sum of the Hamming distance and the 2-norm reaching a threshold from the sums of the Hamming distances and the 2-norms, and using a candidate matrix corresponding to the sum of the Hamming distance and the 2-norm reaching the threshold as the selected condition-compliant matrix.

Alternatively, prior to the calculating a 2-norm of an actual output probability and an estimated output probability of the binary sensor at the current time corresponding to each of the candidate matrices at the current time, the method further includes:

acquiring output probabilities matrix of the binary sensor corresponding to each of the candidate matrices at the current time; and

acquiring an estimation output probability of the binary sensor at the current time corresponding to each of the candidate matrices at the current time according to each of the candidate matrices at the current time and the output probability matrix of the binary sensor corresponding thereto.

According to the method provided in this embodiment, since the binary sensor has a lower dependence on the environment, the binary sensor is deployed in the detection region, difference estimation is performed on each of the candidate matrices at the current time according to output probabilities of the binary sensor at the current time, and an occupation detection result at the current time is selected according to the estimation results. This reduces restrictions caused by the environment to the occupation detection, and improves accuracy of the detection result.

For clear illustration of the method provided in the above embodiment, with reference to the content disclosed in the above embodiment, the following uses Embodiments 2 and 3 as examples to describe the method for occupation detection. For details, reference may be made to Embodiments 2 and 3 as follows.

### Embodiment 2

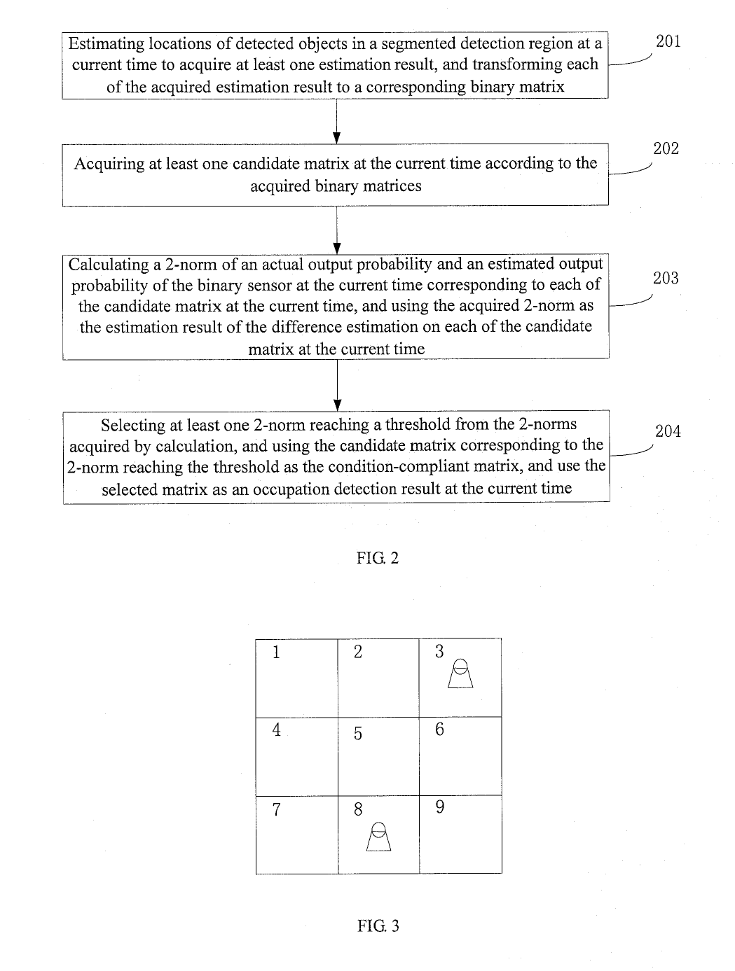

This embodiment provides a method for occupation detection. With reference to the content disclosed in Embodiment 1, for ease of description, this embodiment takes using a 2-norm as an estimation result of performing difference estimation on each of the candidate matrices at a current time as an example to describe the method for occupation detection. Referring to FIG. 2, the method provided in this embodiment includes the following steps:

201: estimating locations of detected objects in a segmented detection region at a current time to acquire at least one estimation result, and transforming each of the acquired estimation results to a corresponding binary matrix.

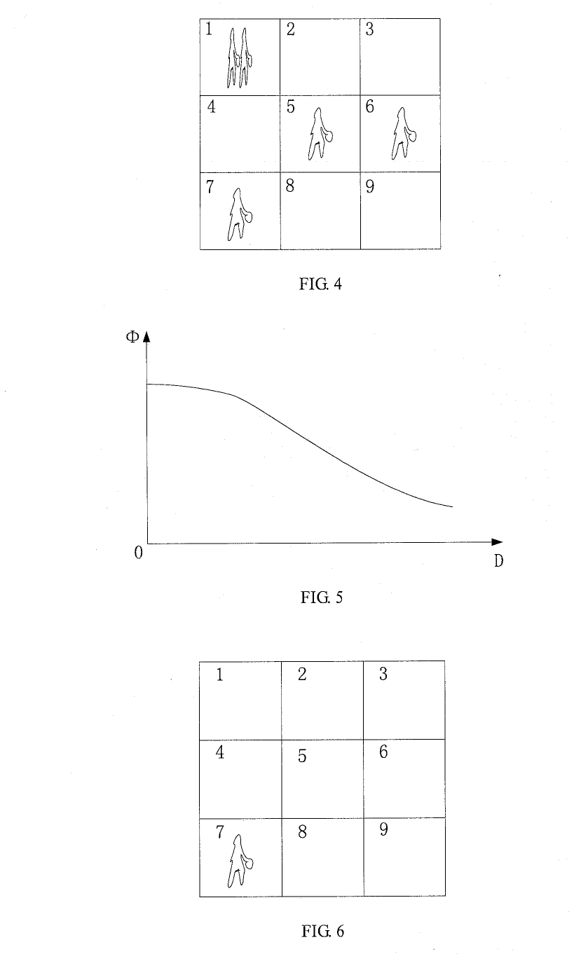

The size of the segmented detection region and the number of segmented detection regions are determined as required. In addition, in any of the segmented detection regions, any number of binary sensors can be deployed. This embodiment does not set limitations to the size of the segmented detection region, the number of segmented detection regions, and the locations and number of deployed binary sensors. Herein, a segmented detection region and deployed binary sensors as shown in FIG. 3 is used as example for description. In FIG. 3, 3×3 detection regions are available after segmentation. For ease of description, the detection regions are marked by numbers 1 to 9, and a binary sensor is respectively deployed in the detection regions 3 and 8. During estimation of the locations of the detected objects in the segmented detection region at the current time, all possible locations of the detected objects may be estimated to acquire at least one estimation result, and each of the estimation results can be transformed to a binary matrix comprised of 0 and 1. Using the detected objects as shown in FIG. 4 as an example, when the current time is t, the detected objects may appear in detection regions 1, 5, 6, and 7, the detection regions where the detected object may appear are identified by 1, and other detection regions are identified by 0. In this case, with regard to the location of the detected objects as shown in FIG. 4, the binary matrix corresponding to the estimation result is as follows:

$${M}_{1}^{t} = ( \begin{matrix}1 & 0 & 0 \\ 0 & 1 & 1 \\ 1 & 0 & 0\end{matrix} )$$

Assuredly, besides the binary matrix corresponding to the above mentioned estimation result, in this embodiment, binary matrices corresponding to other estimation results may also be acquired. This embodiment does not set limitations to the specific estimation result and the binary matrix corresponding thereto.

202: acquiring at least one candidate matrix at the current time according to the acquired binary matrices.

With regard to this step, after the locations of the detection objects in the segmented detection region at the current time is estimated and at least one estimation result is acquired as described in step 201, in step 202, when the at least one candidate matrix at the current time is acquired according to the acquired binary matrices, all binary matrices acquired in step 201 can be used as the acquired candidate matrices at the current time.

Alternatively, when the locations of the detected objects in the segmented detection region are estimated in step 201, all possible locations of the detected objects can be estimated, therefore the number of acquired estimation results and corresponding binary matrices is large. In addition, not all the binary matrices can be selected as the occupation detection result in the subsequent steps. Therefore, under the premise of ensuring accuracy of the subsequent occupation detection results, to reduce the subsequent calculation workload, according to the method provided in this embodiment, during acquisition of the at least one candidate matrix at the current time according to the acquired binary matrices, the step of filtering the acquired binary matrices is employed. The specific filtering method includes but is not limited to filtering the acquired binary matrices using the linear programming relaxation and round-up method. The filtered binary matrices are used as the acquired candidate matrices at the current time. The filtering the acquired binary matrices using the linear programming relaxation and round-up method can be implemented according to the conventional linear programming relaxation and round-up method, which is not detailed herein any further.

No matter which method is used to acquire the at least one candidate matrix at the current time according to the acquired binary matrices, the acquired candidate matrices at the current time and the binary matrices are all used to identify the location of the detection object in the detection region. This embodiment does not set limitations to the number of candidate matrices at the current time, but only uses acquiring the following N candidate matrices at the time t as an example for description, where N is an integer greater than 0.

$${M}_{1}^{t} = ( \begin{matrix}0 & 0 & 0 \\ 0 & 1 & 1 \\ 1 & 0 & 0\end{matrix} ) , \\ {M}_{2}^{t} = ( \begin{matrix}0 & 1 & 0 \\ 0 & 0 & 1 \\ 1 & 0 & 0\end{matrix} ) , \\ {M}_{3}^{t} = ( \begin{matrix}0 & 0 & 0 \\ 0 & 0 & 0 \\ 1 & 0 & 0\end{matrix} ) , \\ {M}_{4}^{t} = ( \begin{matrix}1 & 0 & 0 \\ 0 & 0 & 0 \\ 1 & 0 & 0\end{matrix} ) … {M}_{N}^{t} = ( \begin{matrix}0 & 1 & 0 \\ 0 & 0 & 0 \\ 0 & 0 & 0\end{matrix} ) .$$

203: calculating a 2-norm of an actual output probability and an estimated output probability of the binary sensor at the current time corresponding to each of the candidate matrices at the current time, and using the acquired 2-norm as the estimation result of the difference estimation on each of the candidate matrices at the current time.

The output result of the binary sensor includes only two values, 0 and 1. When an object is present in the measurement range of the binary sensor, the binary sensor outputs 1; otherwise, 0 is output. With the increase of the distance between the detection object and the binary sensor, the probability that the binary sensor outputs 1 is decreased, and a curve of output probability is as shown in FIG. 5. In FIG. 5, the X-coordinate denotes the distance D between the detection object and the binary sensor, and the Y-coordinate denotes the probability Φ that the binary sensor outputs 1. With reference to the schematic curve of output probability of the binary sensor as shown in FIG. 5, and the locations of the binary sensors deployed in the detection regions, a matrix of output probability of the binary sensor can be acquired. With regard to binary sensors s1 and s2 deployed in the detection region as shown in FIG. 3, the matrix of output probability can be as follows:

$$φ ( s 1 ) = ( \begin{matrix}0.6 & 0.9 & 1 \\ 0.3 & 0.7 & 0.9 \\ 0.1 & 0.3 & 0.6\end{matrix} ) , \\ φ ( s 2 ) = ( \begin{matrix}0.3 & 0.6 & 0.3 \\ 0.7 & 0.9 & 0.7 \\ 0.9 & 1 & 0.9\end{matrix} ) .$$

The actual output of the binary sensor can be recorded at intervals of a preset time, and the actual output probability of the binary at the current time can be acquired by statistically collecting the record of the actual output within a preset period. The current time may be a time point which just follows a preset period. Since the output of the binary sensor includes two values 0 and 1, the ratio of the recorded number of times when the binary sensor outputs 1 within the preset period to the recorded number of times when the binary sensor outputs a value within the preset period is used as the actual output probability of the binary at the current time. For example, the recorded number of times when the binary sensor outputs 1 is 3 within the preset period, and the recorded number of times when the binary sensor outputs a value with the preset period is 12, the actual output probability of the binary sensor at the current time acquired by calculation according to the statistics of the actual outputs recorded with the preset period is 3/12=0.25.

During specific implementation, this embodiment sets no limitations to specific manners of acquiring the actual output probability of the binary sensor at the current time. To keep the actual output probability of the binary sensor at the current time consistent with the estimated output probability of the binary sensor at the current time, the following uses the scenario where the ratio of the recorded number of times when the binary sensor outputs 1 within the preset period to the recorded number of times when the binary sensor outputs a value within the preset period is used as the actual output probability of the binary sensor at the current time as an example for detailed description. For example, assume that the preset time is 5 seconds and the preset period is 1 minute, i.e., the actual output of the binary sensor is read every 5 seconds, the total number of times when the binary sensor outputs a value within 1 minute is 12; if the number of times when the binary sensor outputs 1 within 1 minute is 6, the actual output probability of the binary sensor at the time t acquired by calculation according to the statistics of the actual outputs recorded with 1 minute is 6/12=0.5, where the time t may be a time point which just follows the 1-minute time period. Assuredly, the preset time and the preset period may be set to other values. This embodiment does not set limitations to lengths of the preset time and the present period, but only uses R^{t}[S] denoting the actual output probability of the binary sensor at the time t, R^{t}[S]=[0.12, 0.9] as an example for description.

After an output probability matrix of the binary sensor corresponding to each of the candidate matrices at the current time is acquired, an estimation output probability of the binary sensor at the current time corresponding to each of the candidate matrices at the current time can be acquired according to each of the candidate matrices at the current time and the output probability matrix of the binary sensor corresponding thereto. For example, with reference to output probability matrices Φ(s₁) and Φ(s₂) of the binary sensors s₁ and s₂, an estimated output probability P(s₁) of the binary sensor corresponding to each of the candidate matrices at the current time is as follows:

$${P}_{N} ( {s}_{i} ) = 1 - {\prod }_{pq} ( 1 - {M}_{pq} {Φ}_{i} ( {S}_{i} ) ) ;$$

where, i is an identifier of the binary sensor, i is 1 or 2 since two binary sensors are deployed in this embodiment; N is the member of candidate matrix, and p and q are respectively the row and column of the candidate matrix at the current time.

The estimated output probabilities E[S] at the current time of the binary sensor corresponding to each of the candidate matrices at the current time are as follows:

E_{N}^{t}[S]={P_{N}(S₁),P_{N}(S₂), . . . ,P_{N}(Sᵢ)}

With reference to the candidate matrices at the current time acquired in step 202 and the output probability matrix of the binary sensor acquired in step 203, the estimated output probabilities at the current time of binary sensors corresponding to each of the candidate matrices at the current time are as follows:

$${P}_{1} ( {S}_{1} ) = 1 - ( 1 - 0.7 ) ( 1 - 0.9 ) ( 1 - 0.1 ) = 0.973 , \\ {P}_{1} ( {S}_{2} ) = 1 - ( 1 - 0.9 ) ( 1 - 0.7 ) ( 1 - 0.9 ) = 0.997 ;$$

$${P}_{2} ( {S}_{1} ) = 1 - ( 1 - 0.9 ) ( 1 - 0.9 ) ( 1 - 0.1 ) = 0.991 , \\ {P}_{2} ( {S}_{2} ) = 1 - ( 1 - 0.6 ) ( 1 - 0.7 ) ( 1 - 0.9 ) = 0.988 ;$$

$${P}_{3} ( {S}_{1} ) = 1 - ( 1 - 0.1 ) = 0.100 , \\ {P}_{3} ( {S}_{2} ) = 1 - ( 1 - 0.9 ) = 0.900 ;$$

$${P}_{4} ( {S}_{1} ) = 1 - ( 1 - 0.6 ) ( 1 - 0.1 ) = 0.640 , \\ {P}_{4} ( {S}_{2} ) = 1 - ( 1 - 0.3 ) ( 1 - 0.9 ) = 0.930 ;$$

$$…$$

$${P}_{N} ( {S}_{1} ) = 1 - ( 1 - 0.9 ) = 0.900 , \\ {P}_{N} ( {S}_{2} ) = 1 - ( 1 - 0.6 ) = 0.600 .$$

The estimated output probabilities at the current time of all binary sensors corresponding to each of the candidate matrices at the current time are as follows:

$${E}_{1}^{t} [ S ] = \{ 0.973 \; 0.997 \} ;$$

$${E}_{2}^{t} [ S ] = \{ 0.991 \; 0.988 \} ;$$

$${E}_{3}^{t} [ S ] = \{ 0.100 \; 0.900 \} ;$$

$${E}_{4}^{t} [ S ] = \{ 0.640 \; 0.930 \} ;$$

$$…$$

$${E}_{N}^{t} [ S ] = \{ 0.900 \; 0.600 \} .$$

After the actual output probability and estimated output probability of the binary sensor corresponding to each of the candidate matrices at the current time are acquired, a 2-norm of the actual output probability and estimated output probability of the binary sensor corresponding to each of the candidate matrices at the current time is calculated. When E1 is used to denote the acquired 2-norm, E1=∥R(S)−E(S)∥₂, and 2-norms corresponding to the candidate matrices are as follows:

$$E {1}_{1}^{t} = \vert \vert [ 0.1 \; 0.9 ] - [ 0.973 \; 0.997 ] {\vert \vert}_{2} = 0.878 ;$$

$$E {1}_{2}^{t} = \vert \vert [ 0.1 \; 0.9 ] - [ 0.991 \; 0.988 ] {\vert \vert}_{2} = 0.895 ;$$

$$E {1}_{3}^{t} = \vert \vert [ 0.1 \; 0.9 ] - [ 0.100 \; 0.900 ] {\vert \vert}_{2} = 0 ;$$

$$E {1}_{4}^{t} = \vert \vert [ 0.1 \; 0.9 ] - [ 0.640 \; 0.930 ] {\vert \vert}_{2} = 0.541 ;$$

$$…$$

$$E {1}_{N}^{t} = \vert \vert [ 0.1 \; 0.9 ] - [ 0.900 \; 0.600 ] {\vert \vert}_{2} = 0.854 .$$

The acquired 2-norm corresponding to each of the candidate matrices at the current time is used as an estimation result of the different estimation on each of the candidate matrices at the current time. Since the 2-norm is a 2-norm of the actual output probability and estimated output probability of the binary sensor corresponding to each of the candidate matrices at the current time, the 2-norm reflects the difference between the estimated output probability and the actual output probability of the binary sensor at the current time. The smaller the 2-norm, the smaller the difference therebetween; the larger the 2-norm, the greater the difference.

204: selecting at least one 2-norm reaching a threshold from the 2-norms acquired by calculation, and using the candidate matrix corresponding to the 2-norm reaching the threshold as the selected condition-compliant matrix, and using the selected matrix as an occupation detection result at the current time.

With regard to this step, after the 2-norm corresponding to each of the candidate matrices at the current time is acquired as described in step 203, during selection of a 2-norm reaching a threshold from the 2-norms acquired by calculation, the threshold may be a specific threshold. For example, if the threshold is set to 0.5, all candidate matrices corresponding to 2-norms smaller than this threshold can be used as selected condition-compliant matrices, that is, the matrices are used as occupation detection results at the current time; or if the threshold is set to the minimum value among all 2-norms, the candidate matrix corresponding to the minimum 2-norm is used as the selected condition-compliant matrix, that is, the matrix is used as an occupation detection result at the current time. This embodiment does not set limitations to the threshold value. If only the case where the candidate matrix corresponding to the minimum 2-norm is selected as a condition-compliant matrix is used as an example for description, with reference to the 2-norm acquired in step 203, the occupation detection result is the third candidate matrix as follows:

$${M}_{3}^{t} = ( \begin{matrix}0 & 0 & 0 \\ 0 & 0 & 0 \\ 1 & 0 & 0\end{matrix} )$$

As seen from the above candidate matrix, the candidate matrix indicates that the detection object is located in the detection region marked by 7, and the location of the detection object corresponding to the occupation detection result can be as shown in FIG. 6.

According to the method provided in this embodiment, since the binary sensor has a lower dependence on the environment, the binary sensor is deployed in the detection region, difference estimation is performed on each of the candidate matrices at the current time according to output probabilities of the binary sensor at the current time, and an occupation detection result at the current time is selected according to the estimation results. This reduces restrictions caused by the environment to the occupation detection, and improves accuracy of the detection result.

### Embodiment 3

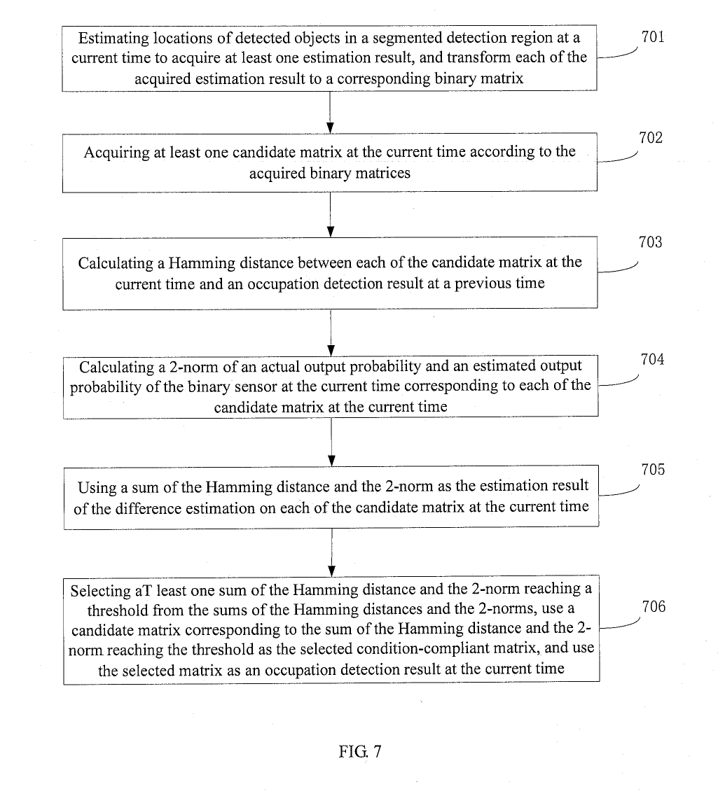

This embodiment provides a method for occupation detection. With reference to the content disclosed in Embodiment 1, for ease of description, this embodiment takes using a sum of a 2-norm and a Hamming distance as an estimation result of performing difference estimation on each of the candidate matrices at a current time as an example to describe the method for occupation detection. Referring to FIG. 7, the method provided in this embodiment includes the following steps:

701: estimating locations of detected objects in a segmented detection region at a current time to acquire at least one estimation result, and transforming each of the acquired estimation results to a corresponding binary matrix.

This step may be implemented using the same manner as step 201 in Embodiment 2. For details, reference may be made to the description in step 201 in Embodiment 2, which is not detailed herein any further.

702: acquiring at least one candidate matrix at the current time according to the acquired binary matrices.

This step may be implemented using the same manner as step 202 in Embodiment 2. For details, reference may be made to the description in step 202 in Embodiment 2, which is not detailed herein any further.

703: calculating a Hamming distance between each of the candidate matrices at the current time and an occupation detection result at a previous time.

The Hamming distance is specifically the number of different bits between corresponding bit values of two code words.

The occupation detection result at the previous time is used as the following matrix:

$${M}_{1}^{t - 1} = ( \begin{matrix}0 & 1 & 0 \\ 0 & 0 & 0 \\ 1 & 0 & 0\end{matrix} ) ;$$

The candidate matrices acquired in step 702 at the current time are as following:

$${M}_{1}^{t} = ( \begin{matrix}0 & 0 & 0 \\ 0 & 1 & 1 \\ 1 & 0 & 0\end{matrix} ) , \\ {M}_{2}^{t} = ( \begin{matrix}0 & 1 & 0 \\ 0 & 0 & 1 \\ 1 & 0 & 0\end{matrix} ) , \\ {M}_{3}^{t} = ( \begin{matrix}0 & 0 & 0 \\ 0 & 0 & 0 \\ 1 & 0 & 0\end{matrix} ) , \\ {M}_{4}^{t} = ( \begin{matrix}1 & 0 & 0 \\ 0 & 0 & 0 \\ 1 & 0 & 0\end{matrix} ) … {M}_{N}^{t} = ( \begin{matrix}0 & 1 & 0 \\ 0 & 0 & 0 \\ 0 & 0 & 0\end{matrix} ) .$$

When E2 is used to denote the Hamming distance, the Hamming distance between each of the candidate matrices at the current time and the occupation detection result at the previous time is specifically as follows:

$$E {2}_{1}^{t} = 3 ;$$

$$E {2}_{2}^{t} = 1 ;$$

$${E2}_{3}^{t} = 1 ;$$

$${E2}_{4}^{t} = 2 ;$$

$$…$$

$$E {2}_{N}^{t} = 1.$$

704: calculating a 2-norm of an actual output probability and an estimated output probability of the binary sensor at the current time corresponding to each of the candidate matrices at the current time.

This step may be implemented using the manner of calculating a 2-norm in step 201 in Embodiment 2. For details, reference may be made to the description in step 203 in Embodiment 2, which is not detailed herein any further. The acquired 2-norms corresponding to the candidate matrices at the current time are as follows:

$$E {1}_{1}^{t} = \vert \vert [ 0.1 \; 0.9 ] - [ 0.973 \; 0.997 ] {\vert \vert}_{2} = 0.878 ;$$

$$E {1}_{2}^{t} = \vert \vert [ 0.1 \; 0.9 ] - [ 0.991 \; 0.988 ] {\vert \vert}_{2} = 0.895 ;$$

$$E {1}_{3}^{t} = \vert \vert [ 0.1 \; 0.9 ] - [ 0.100 \; 0.900 ] {\vert \vert}_{2} = 0 ;$$

$$E {1}_{4}^{t} = \vert \vert [ 0.1 \; 0.9 ] - [ 0.640 \; 0.930 ] {\vert \vert}_{2} = 0.541 ; ;$$

$$…$$

$$E {1}_{N}^{t} = \vert \vert [ 0.1 \; 0.9 ] - [ 0.900 \; 0.600 ] {\vert \vert}_{2} = 0.854 .$$

705: using a sum of the Hamming distance and the 2-norm as the estimation result of the difference estimation on each of the candidate matrices at the current time.

With regard to this step, after the Hamming distance and the 2-norm are acquired as described in steps 703 and 704, when E1 is used to denote the 2-norm, and E2 is used to denote the Hamming distance, the sums of the Hamming distances and the 2-norms corresponding to the candidate matrices are as follows:

$$E {1}_{1}^{t} + E {2}_{1}^{t} = 3.878 ;$$

$$E {1}_{2}^{t} + E {2}_{2}^{t} = 1.895 ;$$

$$E {1}_{3}^{t} + E {2}_{3}^{t} = 1 ;$$

$$E {1}_{4}^{t} + E {2}_{4}^{t} = 2.541 ;$$

$$…$$

$$E {1}_{N}^{t} + E {2}_{N}^{t} = 1.854 .$$

706: selecting at least one sum of the Hamming distance and the 2-norm reaching a threshold from the sums of the Hamming distances and the 2-norms, using a candidate matrix corresponding to the sum of the Hamming distance and the 2-norm reaching the threshold as the selected condition-compliant matrix, and using the selected matrix as an occupation detection result at the current time.

With regard to this step, after the sums of the Hamming distances and the 2-norms corresponding to the candidate matrices at the current time are acquired as described in step 705, during selection of a sum of the Hamming distance and the 2-norm reaching the threshold from the sums of the Hamming distances and the 2-norms, the threshold may be a specific threshold. For example, if the threshold is set to 2, all candidate matrices at the current time corresponding to the sums of the Hamming distances and the 2-norms smaller than this threshold can be used as the selected condition-compliant matrices, that is, the matrices are used as occupation detection results at the current time; or if the threshold is set to the minimum value of the sums of the Hamming distances and the 2-norms, the candidate matrix corresponding to the minimum sum of the Hamming distance and the 2-norm is used as a condition-compliant matrix, that is, the matrix is used as an occupation detection result at the current time. This embodiment does not set limitations to the threshold value. If only the case where the candidate matrix corresponding to the sum of the Hamming distance and the 2-norm is selected as a condition-compliant matrix is used as an example for description, among the sums of the Hamming distances and the 2-norms acquired in step 705, the occupation detection result is the third candidate matrix as follows:

$${M}_{3}^{t} = ( \begin{matrix}0 & 0 & 0 \\ 0 & 0 & 0 \\ 1 & 0 & 0\end{matrix} ) ;$$

As seen from the above candidate matrix, the candidate matrix indicates that the detection object is located in the detection region identified by 7, and the location of the detection object corresponding to the occupation detection result can be as shown in FIG. 6.

According to the method provided in this embodiment, since the binary sensor has a lower dependence on the environment, the binary sensor is deployed in the detection region, difference estimation is performed on each of the candidate matrices at the current time according to output probabilities of the binary sensor at the current time, and an occupation detection result at the current time is selected according to the estimation results. This reduces restrictions caused by the environment to the occupation detection, and improves accuracy of the detection result.

### Embodiment 4

This embodiment provides an apparatus for occupation detection, where the apparatus is configured to perform the method for occupation detection provided in Embodiments 1 to 3. Referring to FIG. 8, the apparatus includes:

an estimating module 81, configured to estimate locations of detected objects in a segmented detection region at a current time to acquire at least one estimation result, and transform each of the acquired estimation results to a corresponding binary matrix;

a first acquiring module 82, configured to acquire at least one candidate matrix at the current time according to the acquired binary matrices acquired by the estimating module 81;

a calculating module 83, configured to perform, according to output probabilities at the current time of at least one binary sensor deployed in the detection region, difference estimation on each of the candidate matrices at the current time acquired by the first acquiring module 82; and

a selecting module 84, configured to select, according to the estimation results acquired by the calculating module 83, at least one condition-compliant matrix from the candidate matrices at the current time acquired by the first acquiring module, and use the selected matrix as an occupation detection result at the current time.

For details about the implementation that the estimating module 81 estimates the location of the detection object in the assigned detection region at the current time, reference may be made to the related description in step 201 in Embodiment 2, which are not detailed herein any further.

With reference to the related description of step 202 in Embodiment 2, the first acquiring module 82 is specifically configured to use the acquired binary matrices acquired by the estimating module 81 as the acquired candidate matrices at the current time; or filter, using the linear programming relaxation and round-up method, the acquired binary matrices acquired by the estimating module, and use the filtered binary matrices as the acquired candidate matrices at the current time.

Alternatively, with reference to the related description of step 203 in Embodiment 2, the calculating module 83 is specifically configured to calculate a 2-norm of an actual output probability and an estimated output probability of the binary sensor at the current time corresponding to each of the candidate matrices at the current time, and use the acquired 2-norm as the estimation result of the difference estimation on each of the candidate matrices at the current time.

Correspondingly, with reference to the related description of step 204 in Embodiment 2, the selecting module 84 is specifically configured to select at least one 2-norm reaching a threshold from the 2-norms acquired by calculation, and use the candidate matrix corresponding to the 2-norm reaching the threshold as the condition-compliant matrix.

Alternatively, with reference to the related description of steps 703-705 in Embodiment 3, the calculating module is specifically configured to calculate a Hamming distance between each of the candidate matrices at the current time and an occupation detection result at a previous time, calculate a 2-norm of an actual output probability and an estimated output probability of the binary sensor at the current time corresponding to each of the candidate matrices at the current time, and use a sum of the Hamming distance and the 2-norm as the estimation result of the difference estimation on each of the candidate matrices at the current time.

Correspondingly, with reference to the related description of step 706 in Embodiment 3, the selecting module 84 is specifically configured to select at least one sum of the Hamming distance and the 2-norm reaching a threshold from the sums of the Hamming distances and the 2-norms acquired through calculation by the calculating module 83, and use a candidate matrix corresponding to the sum of the Hamming distance and the 2-norm reaching the threshold as the selected condition-compliant matrix.

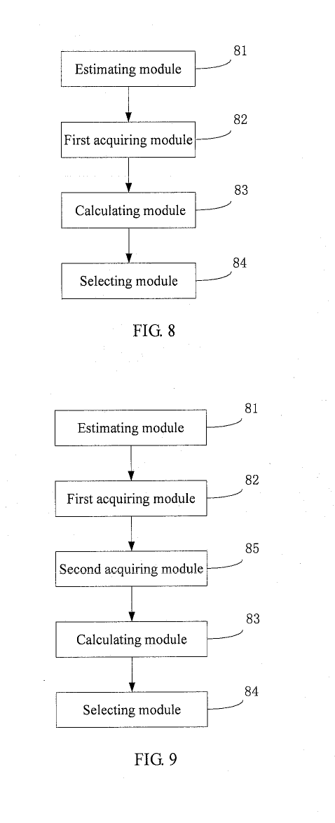

Furthermore, referring to FIG. 9, the device further includes:

a second acquiring module 85, configured to acquire an output probabilities matrix of the binary sensor corresponding to each of the candidate matrices at the current time; and acquire an estimation output probability of the binary sensor at the current time corresponding to each of the candidate matrices at the current time according to each of the candidate matrices at the current time and the output probability matrix of the binary sensor corresponding thereto.

According to the apparatus provided in this embodiment, since the binary sensor has a lower dependence on the environment, the binary sensor is deployed in the detection region, difference estimation is performed on each of the candidate matrices at the current time according to output probabilities of the binary sensor at the current time, and an occupation detection result at the current time is selected according to the estimation results. This reduces restrictions caused by the environment to the occupation detection, and improves accuracy of the detection result.

It should be noted that, during occupation detection performed by the apparatus for occupation detection provided in the above embodiments, the apparatus according to the above embodiments is described by only using division of the above functional modules as an example. In practice, the functions may be assigned to different functional modules for implementation as required. To be specific, the internal structure of the apparatus is divided into different functional modules to implement all or part of the above-described functions. In addition, the apparatus and method for occupation detection provided in the embodiments of the present invention pertain to the same concept, where the specific implementation is elaborated in the method embodiments, which is not be detailed herein any further.

The sequence numbers of the preceding embodiments of the present invention are only for ease of description, but do not denote the preference of the embodiments.

A person skilled in the art should understand that all or part steps of the preceding methods may be implemented by hardware or hardware following instructions of programs. The programs may be stored in a computer readable storage medium. The storage medium may be a read only memory, a magnetic disk, or a CD-ROM.

Described above are merely preferred embodiments of the present invention, but are not intended to limit the present invention. Any modification, equivalent replacement, or improvement made without departing from the spirit and principle of the present invention should fall within the protection scope of the present invention.

What is claimed is:

1. A method for occupation detection, comprising:
estimating locations of detected objects in a segmented detection region at a current time to acquire at least one estimation result, and transforming each of the acquired estimation results to a corresponding binary matrix;
acquiring at least one candidate matrix at the current time according to the acquired binary matrices, and performing difference estimation on each of the candidate matrices at the current time according to output probabilities at the current time of at least one binary sensor deployed in the detection region; and
selecting at least one condition-compliant matrix from the candidate matrices at the current time according to the estimation results, and using the selected matrix as an occupation detection result at the current time.

2. The method according to claim 1, wherein the acquiring at least one candidate matrix at the current time according to the acquired binary matrices specifically comprises:
using the acquired binary matrices as the acquired candidate matrices at the current time; or
filtering the acquired binary matrices using the linear programming relaxation and round-up method, and using the filtered binary matrices as the acquired candidate matrices at the current time.

3. The method according to claim 1, wherein the performing difference estimation on each of the candidate matrices at the current time according to output probabilities at the current time of at least one binary sensor deployed in the detection region specifically comprises:
calculating a 2-norm of an actual output probability and an estimated output probability of the binary sensor at the current time corresponding to each of the candidate matrices at the current time, and using the acquired 2-norm as the estimation result of the difference estimation on each of the candidate matrices at the current time; and
the selecting at least one condition-compliant matrix from the candidate matrices at the current time according to the estimation results specifically comprises:
selecting at least one 2-norm reaching a threshold from the 2-norms acquired by calculation, and using the candidate matrix corresponding to the 2-norm reaching the threshold as the selected condition-compliant matrix.

4. The method according to claim 3, wherein prior to the calculating a 2-norm of an actual output probability and an estimated output probability of the binary sensor at the current time corresponding to each of the candidate matrices at the current time, the method further comprises:
acquiring output probabilities matrix of the binary sensor corresponding to each of the candidate matrices at the current time; and
acquiring an estimation output probability of the binary sensor at the current time corresponding to each of the candidate matrices at the current time according to each of the candidate matrices at the current time and the output probability matrix of the binary sensor corresponding thereto.

5. The method according to claim 1, wherein the performing difference estimation on each of the candidate matrices at the current time according to output probabilities at the current time of at least one binary sensor deployed in the detection region specifically comprises:
calculating a Hamming distance between each of the candidate matrices at the current time and an occupation detection result at a previous time, calculating a 2-norm of an actual output probability and an estimated output probability of the binary sensor at the current time corresponding to each of the candidate matrices at the current time, and using a sum of the Hamming distance and the 2-norm as the estimation result of the difference estimation on each of the candidate matrices at the current time; and
the selecting at least one condition-compliant matrix from the candidate matrices at the current time according to the estimation results specifically comprises:
selecting at least one sum of the Hamming distance and the 2-norm reaching a threshold from the sums of the Hamming distances and the 2-norms, and using a candidate matrix corresponding to the sum of the Hamming distance and the 2-norm reaching the threshold as the selected condition-compliant matrix.

6. The method according to claim 5, wherein prior to the calculating a 2-norm of an actual output probability and an estimated output probability of the binary sensor at the current time corresponding to each of the candidate matrices at the current time, the method further comprises:
acquiring output probabilities matrix of the binary sensor corresponding to each of the candidate matrices at the current time; and
acquiring an estimation output probability of the binary sensor at the current time corresponding to each of the candidate matrices at the current time according to each of the candidate matrices at the current time and the output probability matrix of the binary sensor corresponding thereto.

7. An apparatus for occupation detection, comprising:
an estimating module, configured to estimate locations of detected objects in a segmented detection region at a current time to acquire at least one estimation result, and transform each of the acquired estimation results to a corresponding binary matrix;
a first acquiring module, configured to acquire at least one candidate matrix at the current time according to the acquired binary matrices acquired by the estimating module;
a calculating module, configured to perform, according to output probabilities at the current time of at least one binary sensor deployed in the detection region, difference estimation on each of the candidate matrices at the current time acquired by the first acquiring module; and
a selecting module, configured to select, according to the estimation results acquired by the calculating module, at least one condition-compliant matrix from the candidate matrices at the current time acquired by the first acquiring module, and use the selected matrix as an occupation detection result at the current time.

8. The apparatus according to claim 7, wherein the first acquiring module is specifically configured to use the acquired binary matrices acquired by the estimating module as the acquired candidate matrices at the current time; or filter, using the linear programming relaxation and round-up method, the acquired binary matrices acquired by the estimating module, and use the filtered binary matrices as the acquired candidate matrices at the current time.

9. The apparatus according to claim 7, wherein the calculating module is specifically configured to calculate a 2-norm of an actual output probability and an estimated output probability of the binary sensor at the current time corresponding to each of the candidate matrices at the current time, and use the acquired 2-norm as the estimation result of the difference estimation on each of the candidate matrices at the current time; and
the selecting module is specifically configured to select at least one 2-norm reaching a threshold from the 2-norms acquired by calculation, and use the candidate matrix corresponding to the 2-norm reaching the threshold as the selected condition-compliant matrix.

10. The apparatus according to claim 9, further comprising:
a second acquiring module, configured to acquire output probabilities matrix of the binary sensor corresponding to each of the candidate matrices at the current time; and acquire an estimation output probability of the binary sensor at the current time corresponding to each of the candidate matrices at the current time according to each of the candidate matrices at the current time and the output probability matrix of the binary sensor corresponding thereto.

11. The apparatus according to claim 7, wherein the calculating module is specifically configured to calculate a Hamming distance between each of the candidate matrices at the current time and an occupation detection result at a previous time, calculate a 2-norm of an actual output probability and an estimated output probability of the binary sensor at the current time corresponding to each of the candidate matrices at the current time, and use a sum of the Hamming distance and the 2-norm as the estimation result of the difference estimation on each of the candidate matrices at the current time; and
the selecting module is specifically configured to select at least one sum of the Hamming distance and the 2-norm reaching a threshold from the sums of the Hamming distances and the 2-norms, and use a candidate matrix corresponding to the sum of the Hamming distance and the 2-norm reaching the threshold as the selected condition-compliant matrix.

12. The apparatus according to claim 11, further comprising:
a second acquiring module, configured to acquire output probabilities matrix of the binary sensor corresponding to each of the candidate matrices at the current time; and acquire an estimation output probability of the binary sensor at the current time corresponding to each of the candidate matrices at the current time according to each of the candidate matrices at the current time and the output probability matrix of the binary sensor corresponding thereto.
